(19) United States
(12) Patent Application Publication
(10) Pub. No.: US 2008/0107108 A1
(43) Pub. Date: May 8, 2008

(54) SYSTEM AND METHOD FOR ENABLING FAST SWITCHING BETWEEN PSSE CHANNELS

(75) Inventor: Imed Bouazizi, Tampere (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/934,699

(22) Filed: Nov. 2, 2007

Related U.S. Application Data
(60) Provisional application No. 60/856,633, filed on Nov. 3, 2006.

(51) Int. Cl. H04L 12/56

(52) U.S. Cl. 370/389

(57) ABSTRACT

A system and method for replacing existing media streams of a streaming session with alternative media streams, without tearing down the RTSP session and providing only a minimal delay. In various embodiments of the present invention, the client indicates to the server that it wishes to replace a media stream that it is currently consuming with another stream by sending a switch command to the streaming server, with the switch command indicating the old media stream and the new media stream. A feature is also provided for enabling the receiver to mute and unmute a single media stream. A client may query the server to find out whether fast channel switching is supported by the server.

### FIELD OF THE INVENTION

The present invention relates generally to the 3^{rd} Generation Partnership Project (3GPP) Packet-Switched Streaming Service (PSS). More particularly, the present invention relates to the use of fast channel switching in the PSS service.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

3GPP PSS is the 3GPP's solution for enabling packet-switched streaming in mobile devices. PSS defines protocols and media codecs for enabling the streaming service for mobile devices. PSS is based on the Real Time Streaming Protocol (RTSP) for session setup and control. RTSP is discussed in the Network Working Group's Request for Comments (RFC) No. 2326 and can be found at www.ietf.org/rfc/rfc2326.txt, the content of which is incorporated herein by reference in its entirety. The Real-Time Transport Protocol (RTP)/RTP Control Protocol (RTCP) and the RTP/Audio Video Protocol (AVP) profile are used for the media transport and for feedback exchange between the client the and server. RTP/RTCP is discussed in the Network Working Group's Request for Comments (RFC) No. 3550 and can be found at www.ietforg/rfc/rfc3550.txt, the content of which is incorporated herein by reference in its entirety. RTP/AVP discussed in the Network Working Group's Request for Comments (RFC) No. 3551 and can be found at www.ietforg/rfc/rfc3551.txt, the content of which is incorporated herein by reference in its entirety.

3GPP PSS defines the usage of several media codecs. For video, 3GPP PSS defines the usage for H.263 Profile 3 Level 45; MPEG-4 Visual Simple Profile Level 0b; and H.264 Baseline Profile Level 1b. For video, 3GPP PSS defines the usage for Enhanced aacPlus and Extended AMR-WB. 3GPP PSS also supports other media types, such as still images and timed text. In addition, 3GPP PSS defines several extensions to RTSP to allow for the exchange of link characteristics, media adaptation, and quality of experience (QoE) information.

3GPP Packet-switched Streaming Service enhancements (PSSe) are currently being defined in 3GPP. The goal of these enhancements is to define extensions to 3GPP PSS Release No. 6 to optimize the streaming service. In PSSE, fast channel switching has been identified as an important field of optimization for the PSS service. In 3GPP PSS Release No. 6, switching between different channels, even on the same server, is a very lengthy procedure and requires a significant amount of time to complete. The procedure involves tearing down the old RTSP session, transmitting data, and setting up a new RTSP session. Each of these steps involves message exchanges between the PSSe server and the client. This procedure is depicted, for example, in FIG. 1.

One of the goals of the PSSe is to reduce the channel switch time as much as possible. Several requirements have been set for implementing potential solutions. These requirements include (1) PSSe should reuse as much of PSSe Release No. 6 as possible; (2) PSSe should be backwards compatible with pre-Release No. 7 PSS clients; (3) the number of fast channel switching solutions should be minimized; and (4) the channel switch time be the time between the initiation of the switching action until the rendering time of the first media unit.

A number of issues arise in use cases where a user decides to switch to a different content item that is provided by the same PSSe server. The user terminal or user equipment (UE) has a list of content items (or channels) that are provided by a PSSe server. Each content item is identified by a RTSP uniform resource locator (URL) or uniform resource identifier (URI) which is used to control the content. The UE determines from the list through the RTSP URL or URI that two or several channels are served by the same PSSe server. While consuming one of the channels, the user may decide to switch to a new channel. The new channel is usually a presentation that typically comprises the same number of media streams (typically one audio stream and one video stream). Ideally, the receiver should be able to reuse the same RTSP session for controlling the streaming session. Furthermore, an important reduction of the channel switch time can be achieved if the same transport parameters are reused for the new media streams. In other words, the new video stream reuses the same connection parameters as the old video stream, and the new audio stream reuses the same connection parameters as the old audio stream. However, in this situation, a number of issues need to be taken into account. First, the media codec parameters may differ between the old media stream and the new media stream. Second, the receiver needs to be able to differentiate between packets of the old stream and the new stream. Third, receiver needs to be able to immediately synchronize the media streams of the new presentation. A mechanism for replacing single media streams of a presentation is necessary, and this mechanism needs to take prior requirements into account as well.

One proposal for addressing the issue of channel switching, which is discussed at www.ietforg/internet-drafts/draft-einarsson-mmusic-rtsp-macuri-00.txt and is incorporated herein by reference in its entirety, involves defining a method for declaring multiple aggregated URLs for a single Session Description Protocol (SDP) file. However, this concept suffers from several drawbacks. For example, this method does not support different media codecs and configuration parameters for the media streams between an old channel and a new channel. As a result, the SDP must be as complete as possible in order to cover all possible media stream characteristics. However, this is not always possible, as there are some parameters, such as the protection key, that usually differ from one media stream to another. Additionally, this arrangement does not fully support the dynamic addition and removal of channels, as all of the channels are described in the SDP. The proposal containing this arrangement foresees a possibility for indicating that the list of channels is delivered out-of-band through other mechanisms, but it is not defined how this out-of-band signaling and the indication of the relationship to the SDP description is accomplished. Still further, this method involves modifying the URLs of the single media streams, which are used by the media server to locate the content (especially in the case of pre-stored content). RTSP defines that the aggregate URL as being opaque and is not interpreted by the server for locating the media components. Instead, the media URLs are used for this purpose. Therefore, with this method, the server needs to change the interpretation of the media URL each time that a channel switch is performed.

It would therefore be desirable to develop a system and method for enabling fast switching while, at the same time, addressing the shortcomings of the system described above.

### SUMMARY OF THE INVENTION

Various embodiments of the present invention involve a system and method for replacing existing media streams of a streaming session with alternative media streams, without tearing down the RTSP session and providing only a minimal delay. In the various embodiments, the client indicates to the server that it wishes to replace a media stream that it is currently consuming with another stream by sending a switch command to the streaming server, with the switch command indicating the old media stream and the new media stream. With this command, the channel switch time is short, as there is no need to negotiate transport parameters or configure firewalls.

In addition to allowing for flexible channel switching with minimal delay, the various embodiments of the present invention also allow for differences in media parameters, and only a single bundle of parallel requests is needed to start a new channel. The various embodiments of the present invention can be used both in unicast media streams and multicast media streams.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a depiction of a channel switch procedure as outlined in PSS Release No. 6;

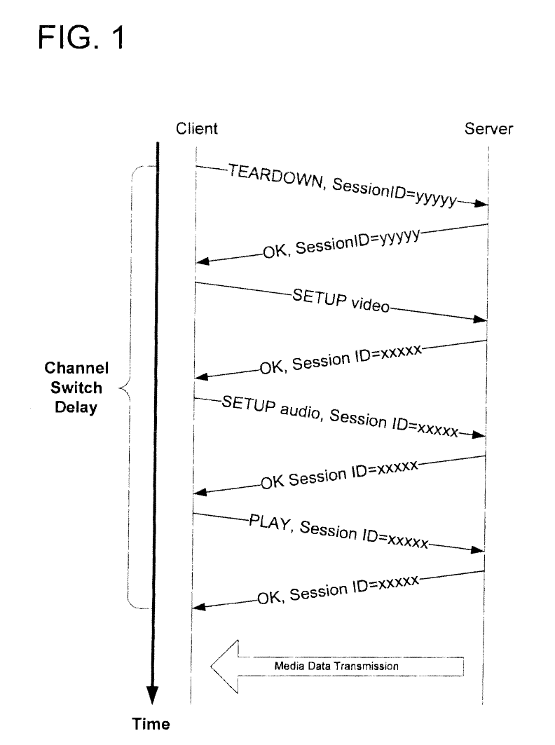

FIG. 2 is an overview diagram of a system within which the present invention may be implemented;

FIG. 3 is a perspective view of a mobile telephone that can be used in the implementation of the present invention;

FIG. 4 is a schematic representation of the telephone circuitry of the mobile telephone of FIG. 3;

FIG. 5 is a depiction of a channel switch procedure as conducted according to one embodiment of the present invention;

FIG. 6 is a depiction of a MUTE/UNMUTE procedure as conducted according to one embodiment of the present invention; and

FIG. 7 is another depiction of a MUTE/UNMUTE procedure as conducted according to one embodiment of the present invention.

### DETAILED DESCRIPTION OF VARIOUS EMBODIMENTS

Various embodiments of the present invention involve a system and method for replacing existing media streams of a streaming session with alternative media streams, without tearing down the RTSP session and providing only a minimal delay. In the various embodiments, the client indicates to the server that it wishes to replace a media stream that it is currently consuming with another stream by sending a switch command to the streaming server, with the switch command indicating the old media stream and the new media stream. With this command, the channel switch time is short, as there is no need to negotiate transport parameters or configure firewalls. As discussed herein, it should be noted that the term “media stream” may comprise audio and/or video streams, as well as potentially other types of content or data. For example, still images, subtitles, etc. may also be in a media stream.

The various embodiments discussed herein allow for improved flexibility with regard to the media stream parameters in the SDP, as the media stream parameters do not have to be shared between the old media stream and the new media stream. Additionally, the embodiments allow for the identification of packets of the old and the new media streams by changing the payload types of the new media stream so as to be unique and different from those of the old channel. This allows the receiver to correctly handle the packets. This system also allows for the reuse of the same RTSP session, thereby reducing the channel switch time. Lastly, the system described herein does not change the media URLs or Uniform resource identifiers (URIs), thereby permitting the server to locate the content as usual.

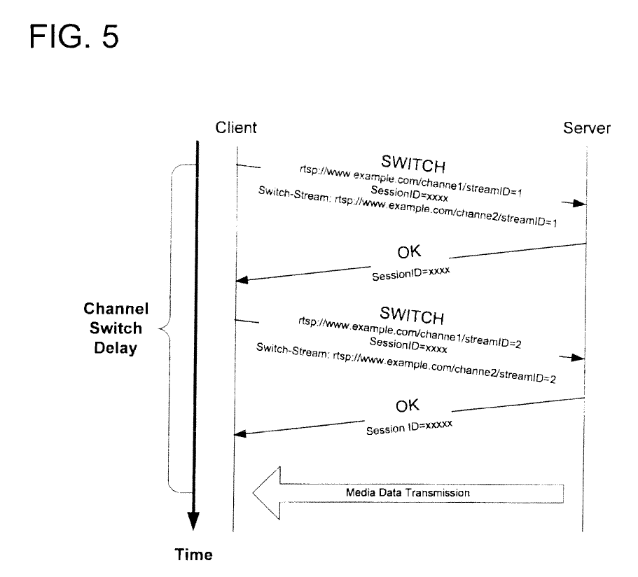

According to various embodiments of the present invention, a RTSP SWITCH instruction is used by a client to indicate to a server to replace one media stream with another. The SWITCH method takes the URL or URI of the old media stream as a parameter. The URL or URI of the new media stream is indicated in a new header field, “Switch-Stream”, of the request. If the operation succeeds, the PSSe server replies with a 200 OK message, including RTP-info and “Switch-Stream” header fields. The response of the server includes an indication of the new payload types that will be used for the delivery of the new media stream data units. Other information can also be included in the server response. The reason for a new payload type is that, in the session announcement, SDP files are sent to the receivers. These SDP descriptions contain dynamic payload types (as the media codecs in use in PSS do not map to static payload types). However, those dynamic payload types may be the same for different channels. If this is the case and if the receiver switches from a channel 1 video stream (with payload type (PT)=100) to a channel 2 video stream (with PT=100), then the receiver will not be able to detect which packet belongs to which channel. This is avoided via the ability to assign a new payload type to the media stream of the new channel, ensuring that the new payload type is different from the payload type used by the old channel. The response also includes a RTP-Info header to indicate the sequence number and timestamp of the first packet of the new media stream, as well as the synchronization source (SSRC). The RTP-info header is defined in draft-ietf-mmusic-rfc2326bis-13 (section 13.48), which can be found at www.ietforg/internet-drafts/draft-ietf-mmusic-rfc2326bis-13.txt and is incorporated herein by reference in its entirety. A switch procedure conducted in accordance with this embodiment is depicted in FIG. 5.

An example of the channel switch procedure is as follows.

Client−>Server: SWITCH
rtsp://www.example.com/movie1.3gp/trackID=1 RTSP/2.0

<-------------------- URI/URL of the old stream
----------->

CSeq: 1

Session: 39487876
User-Agent: NokiaClient/1.0
[new header] Switch-Stream:
url=”rtsp://www.example.com/movie2.3gp/trackID=1”

<-------------------- URI/URL of the old stream
----------->

Server−>Client: RTSP/2.0 200 OK

CSeq: 1
Server: NokiaServer/1.1
Session: 39487876
Range: npt=0−
Switch-Stream:
url=”rtsp://www.example.com/movie2.3gp/trackID=1”;

payloadtype={104}

RTP-Info: url=”rtsp://www.example.com/movie2.3gp/trackID=1”;

ssrc=29873786;seq=9900;rtptime=339872

The above example shows how a switch from the video stream of the first channel “movie1.3gp” to the video stream of the second channel “movie2.3gp”. The session ID and the aggregate control URL or URI does not change. However the control URL or URI of the media stream changes. The same process is also performed for the audio stream. The two switch requests for the audio and video may be sent in parallel to further reduce the channel switch time. These new payload types are used to replace the payload types that were originally indicated in the SDP of the new channel. The new payload types appear in the same order as the payload types in the original SDP and replace them in the same order of appearance. This allows the client to detect which packet belongs to which channel and to handle the packets in an appropriate manner.

The following is an example of an SDP file for the first channel:

v=0

o=−950814089 950814089 IN IP4 144.132.134.67

s=PSSe channel 1

e=foo@bar.com

c=IN IP4 0.0.0.0

b=AS:77

b=TIAS:69880

t=0 0

a=maxprate:20

a=range:npt=0−59.3478

a=control:*

m=audio 0 RTP/AVP 97 98

b=AS:13

b=TIAS:12680

b=RR:350

b=RS:300

a=maxprate:5

a=rtpmap:97 AMR/8000

a=fmtp:97 octet-align=1

a=fmtp:98 opt=97; ContentID=“content1000221@ContentIssuer.com”;

RightsIssuerURL=“http://drm.rightsserver.org/1000221”;

IVnonce=JDE0SYJCAAqWUwWJiBM=; SelectiveEncryption=1

a=control: streamID=0

a=3 GPP-Adaptation-Support:2

b=AS:64

b=TIAS:59200

b=RR:2000

b=RS:1200

a=rtpmap:99H263-2000/90000

a=fmtp:99 profile=3;level=10

a=fmtp:100 opt=99; ContentID=“content6188164@ContentIssuer.com”;

RightsIssuerURL=“http://drm.rightsserver.org/6188164”; IVnonce=IwOSRWeSAUiVEiN5gVA=

a=control: streamID=1

a=3GPP-Adaptation-Support:1

The following is an example of an SDP file for the second channel, before the channel switch occurs:

v=0

o=−950814089 950814089 IN IP4 144.132.134.67

s=PSSe channel 1

e=foo@bar.com

c=IN IP4 0.0.0.0

b=AS:77

b=TIAS:69880

t=0 0

a=maxprate:20

a=range:npt=0−59.3478

a=control:*

m=audio 0 RTP/AVP 97 98

b=AS:13

b=TIAS:18000

b=RR:400

b=RS:350

a=maxprate:8

a=rtpmap:97 AMR/8000

a=fmtp:97 octet-align=1

a=rtpmap:98 RTP-ENC-AESCM128/8000

a=fmtp:98 opt=97; ContentID=“content 1034321@ContentIssuer.com”;

RightsIssuerURL=“http://drm.rightsserver.org/1034321”;

IVnonce=ABE0SYJCACEFUwWJiBM=; SelectiveEncryption=1

a=control: streamID=0

a=3 GPP-Adaptation-Support:2

m=video 0 RTP/AVP 99 100

b=AS:64

b=TIAS:52400

b=RR:2100

b=RS:800

a=rtpmap:99H264/90000

a=fmtp:99 profile-level-id=42E00C; sprop-parameter-

sets=J0LgHvQKD9CAAAD6AAAeMGVA; A9DCg

a=rtpmap:100 RTP-ENC-AESCM128/90000

a=fmtp:100 opt=99; ContentID=“content6188164@ContentIssuer.com”;

RightsIssuerURL=“http://drm.rightsserver.org/6188164”; IVnonce=IwOSRWeSAgDa9EiN5gVA=

a=control: streamID=1

a=3GPP-Adaptation-Support:1

After the channel switch, payload types 102, 103, 104, and 105 are used instead of 97, 98, 99, and 100. These new payload types are indicated in the SWITCH-STREAM header. The following shows the SDP file of channel 2 after the channel switch:

v=0

o=−950814089 950814089 IN IP4 144.132.134.67

s=PSSe channel 1

e=foo@bar.com

c=IN IP4 0.0.0.0

b=AS:77

b=TIAS:69880

t=0 0

a=maxprate:20

a=range:npt=0−59.3478

a=control:*

m=audio 0 RTP/AVP 102 103

b=AS:13

b=TIAS:18000

b=RR:400

b=RS:350

a=maxprate:8

a=rtpmap:102 AMR/8000

a=fmtp:102 octet-align=1

a=rtpmap:103 RTP-ENC-AESCM128/8000

a=fmtp:103 opt=102; ContentID=“content1034321@ContentIssuer.com”;

RightsIssuerURL=“http://drm.rightsserver.org/1034321”;

IVnonce=ABE0SYJCACEFUwWJiBM=; SelectiveEncryption=1

a=control: streamID=0

a=3 GPP-Adaptation-Support:2

m=video 0 RTP/AVP 104 105

b=AS:64

b=TIAS:52400

b=RR:2100

b=RS:800

a=maxprate:17

a=rtpmap:104H264/90000

a=fmtp:104 profile-level-id=42E00C; sprop-parameter-

sets=J0LgHvQKD9CAAAD6AAAeMGVA; A9DCg

a=rtpmap:105 RTP-ENC-AESCM128/90000

a=fmtp:105 opt=104; ContentID=“content6188164@ContentIssuer.com”;

RightsIssuerURL=“http://drm.rightsserver.org/6188164”; IVnonce=IwOSRWeSAgDa9EiN5gVA=

a=control: streamID=1

a=3GPP-Adaptation-Support:1

In addition to the above, a client may query the server to find out whether fast channel switching is supported by the server. This can be achieved using a RTSP OPTIONS method. A new feature tag, for example, a “3gpp.org.psse:channel-switch” tag, is defined and may be used by the receiver and the sender in the “Supported” header field to indicate their support of the channel switch feature. Alternatively, the receiver may attempt to send the switch command, and if the response of the server is an error message that indicates that the method is not supported, the client can assume that fast channel switching is not supported.

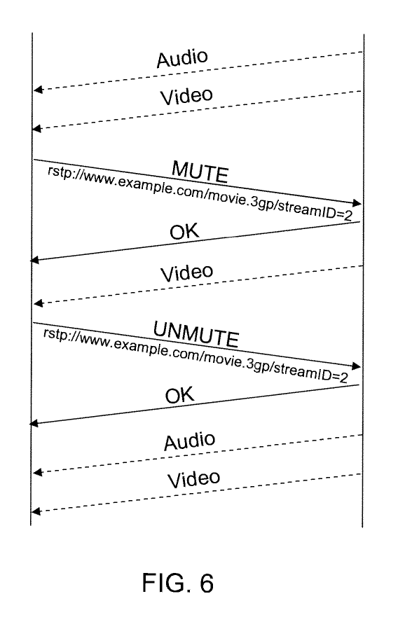

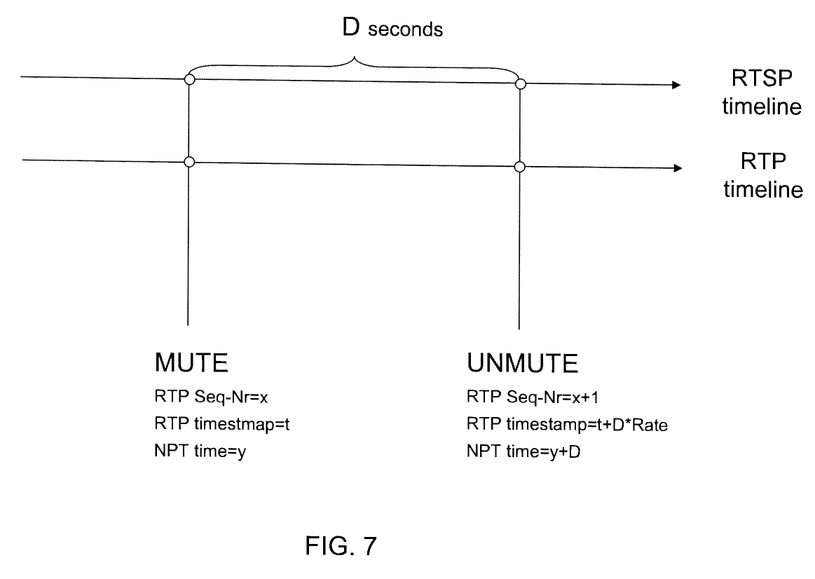

Various embodiments of the present invention also add a new feature to RTSP which enables the receiver to mute a single media stream. For example, FIGS. 6 and 7 illustrate MUTE/UNMUTE procedures according to various embodiments of the present invention. This can be used to instruct the server to stop sending data from a particular media stream, and it can be applied to media streams of an aggregate session. The timeline continues to run as usual, so once an unmute instruction is sent, the stream resumes from the current position and not from the position where the mute has been performed. This is used to maintain synchronization.

The MUTE command is applied to a single media stream in order to stop transmission of media packets by the server. The presentation timeline is not altered and continues as usual, as is the case with a PAUSE command. The difference between the MUTE command and the PAUSE command is that the PAUSE command cannot be applied to a single media stream of a presentation and, if the PAUSE command is applied, the RTSP session state changes to ready. The MUTE command does not change the RTSP session state and it can be applied to a session in the PLAY state. The UNMUTE method is used to resume the transmission of media packets of a previously muted media stream. The server then resumes from the old sequence number incremented by one, but with a timestamp indicating the current presentation time (i.e. including the time during which the media stream was muted).

The following is an example of the MUTE method:

Client−>Server: MUTE rtsp://www.example.com/movie1.3gp/trackID=2
RTSP/2.0

CSeq: 12

Session: 39487876
User-Agent: NokiaClient/1.0
Server−>Client: RTSP/2.0 200 OK
CSeq: 12
Server: NokiaServer/1.1
Session: 39487876

The following is an example of the UNMUTE method:

Client−>Server: UNMUTE
rtsp://www.example.com/movie1.3gp/trackID=2
RTSP/2.0

CSeq: 13

Session: 39487876
User-Agent: NokiaClient/1.0
Server−>Client: RTSP/2.0 200 OK
CSeq: 13
Server: NokiaServer/1.1
Session: 39487876

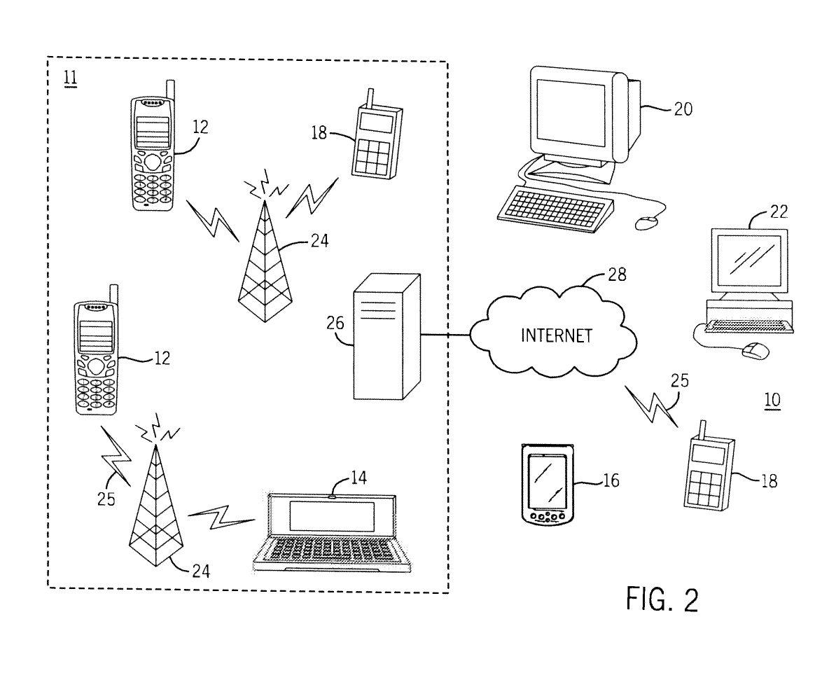

FIG. 2 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 2 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile telephone 12, a combination PDA and mobile telephone 14, a PDA 16, an integrated messaging device (IMD) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

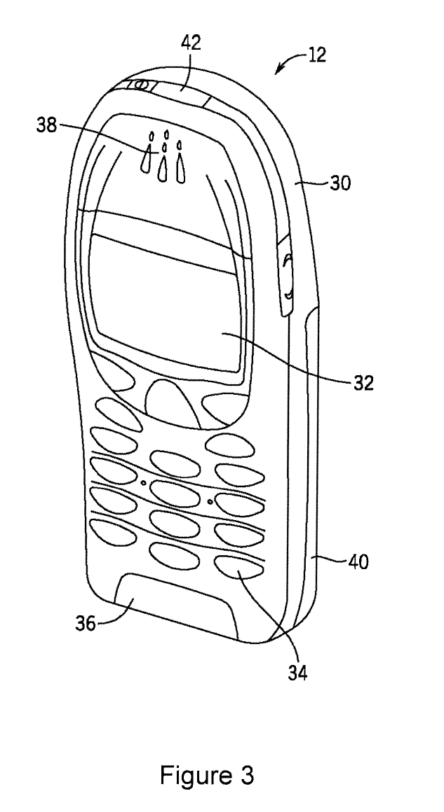

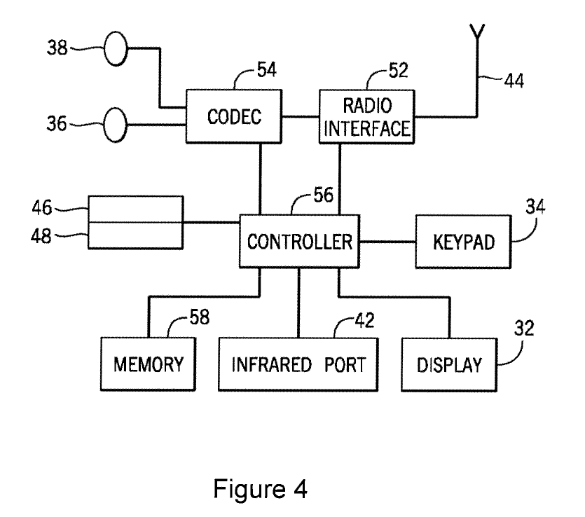

FIGS. 3 and 4 show one representative mobile telephone 12 within which the present invention may be implemented. It should be understood, however, that the present invention is not intended to be limited to one particular type of mobile telephone 12 or other electronic device. The mobile telephone 12 of FIGS. 3 and 4 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method, comprising:
transmitting an instruction to a sending device that a first media stream be replaced with a second media stream, the instruction including identifiers for both the first media stream and the second media stream; and
in response to the transmitted instruction, receiving a response including an indication of new payload types that are to be used for delivery of data units for the second media stream.

2. The method of claim 1, wherein the identifiers for the first media stream and the second media stream comprise one of uniform resource locators (URLs) and uniform resource identifiers (URIs).

3. The method of claim 2, wherein the one of the URL and URI for the second media stream is indicated in a “switch stream” request header for the instruction.

4. The method of claim 1, wherein the first and second media streams comprise video streams.

5. The method of claim 1, wherein the first and second media streams comprise audio streams.

6. The method of claim 1, wherein the new payload types replace previous payload types originally identified for the second media stream.

7. The method of claim 6, wherein the new payload types appear in the same order as the previous payload types originally appeared.

8. The method of claim 1, further comprising providing an indication that fast channel switching is supported.

9. The method of claim 1, further comprising:
before transmitting the instruction, transmitting a query regarding whether the sending device supports fast channel switching; and
in response to the query, receiving an indication as to whether the sending device supports fast channel switching.

10. A computer program product, embodied in a computer-readable medium, comprising:
computer code for transmitting an instruction that a first media stream be replaced with a second media stream, the instruction including identifiers for both the first media stream and the second media stream; and
computer code for, in response to the transmitted instruction, receiving a response including an indication of new payload types that are to be used for delivery of data units for the second media stream.

11. The computer program product of claim 10, further comprising computer code for providing an indication that fast channel switching is supported.

12. The computer program product of claim 10, further comprising:
computer code for transmitting a query regarding whether the sending device supports fast channel switching; and
computer code for, in response to the query, receiving an indication as to whether the sending device supports fast channel switching.

13. An apparatus, comprising:
a processor; and
a memory unit communicatively connected to the processor and including:
computer code for, before transmitting the instruction, transmitting an instruction that a first media stream be replaced with a second media stream, the instruction including identifiers for both the first media stream and the second media stream; and
computer code for, in response to the transmitted instruction, receiving a response including an indication of new payload types that are to be used for delivery of data units for the second media stream.

14. The apparatus of claim 13, wherein the identifiers for the first media stream and the second media stream comprise one of uniform resource locators (URLs) and uniform resource identifiers (URIs).

15. The apparatus of claim 14, wherein the one of the URL and URI for the second media stream is indicated in a “switch stream” request header for the instruction.

16. The apparatus of claim 13, wherein the first and second media streams comprise video streams.

17. The apparatus of claim 13, wherein the first and second media streams comprise audio streams.

18. The apparatus of claim 13, wherein the new payload types replace previous payload types originally identified for the second media stream.

19. The apparatus of claim 18, wherein the new payload types appear in the same order as the previous payload types originally appeared.

20. The apparatus of claim 13, wherein the memory unit further comprises computer code for providing an indication that fast channel switching is supported.

21. The apparatus of claim 13, wherein the memory unit further comprises:
computer code for, before transmitting the instruction, transmitting a query regarding whether the sending device supports fast channel switching; and
computer code for, in response to the query, processing a received indication as to whether the sending device supports fast channel switching.

22. A method, comprising:
receiving an instruction that a first media stream be replaced with a second media stream, the instruction including identifiers for both the first media stream and the second media stream; and
in response to the received instruction, transmitting a response including an indication of new payload types that are to be used for delivery of data units for the second media stream.

23. The method of claim 22, wherein the identifiers for the first media stream and the second media stream comprise one of uniform resource locators (URLs) and uniform resource identifiers (URIs).

24. The method of claim 23, wherein the one of the URL and URI for the second media stream is indicated in a “switch stream” request header for the instruction.

25. The method of claim 22, wherein the first and second media streams comprise video streams.

26. The method of claim 22, wherein the first and second media streams comprise audio streams.

27. The method of claim 22, wherein the new payload types replace previous payload types originally identified for the second media stream.

28. The method of claim 27, wherein the new payload types appear in the same order as the previous payload types originally appeared.

29. The method of claim 22, further comprising providing an indication that fast channel switching is supported.

30. The method of claim 22, further comprising:
before receiving the instruction, receiving a query regarding whether fast channel switching is supported; and
in response to the query, transmitting an indication as to whether fast channel switching is supported.

31. A computer program product, embodied in a computer-readable medium, comprising:
computer code for receiving an instruction that a first media stream be replaced with a second media stream, the instruction including identifiers for both the first media stream and the second media stream; and
computer code for, in response to the received instruction, transmitting a response including an indication of new payload types that are to be used for delivery of data units for the second media stream.

32. The computer program product of claim 31, further comprising computer code for providing an indication that fast channel switching is supported.

33. The computer program product of claim 31, further comprising:
computer code for, before receiving the instruction, receiving a query regarding whether fast channel switching is supported; and
computer code for, in response to the query, transmitting an indication as to whether fast channel switching is supported.

34. An apparatus, comprising:
a processor; and
a memory unit communicatively connected to the processor and including:
computer code for receiving an instruction that a first media stream be replaced with a second media stream, the instruction including identifiers for both the first media stream and the second media stream; and
computer code for, in response to the received instruction, transmitting a response including an indication of new payload types that are to be used for delivery of data units for the second media stream.

35. The apparatus of claim 34, wherein the identifiers for the first media stream and the second media stream comprise one of uniform resource locators (URLs) and uniform resource identifiers (URIs).

36. The apparatus of claim 35, wherein the one of the URL and URI for the second media stream is indicated in a “switch stream” request header for the instruction.

37. The apparatus of claim 34, wherein the first and second media streams comprise video streams.

38. The apparatus of claim 34, wherein the first and second media streams comprise audio streams.

39. The apparatus of claim 34, wherein the new payload types replace previous payload types originally identified for the second media stream.

40. The apparatus of claim 39, wherein the new payload types appear in the same order as the previous payload types originally appeared.

41. The apparatus of claim 34, wherein the memory unit further comprises computer code for providing an indication that fast channel switching is supported.

42. The apparatus of claim 34, wherein the memory unit further comprises:
computer code for, before receiving the instruction, receiving a query regarding whether fast channel switching is supported; and
computer code for, in response to the query, transmitting an indication as to whether fast channel switching is supported.

43. A method, comprising:
transmitting a first request to a server that the transmission of media packets in a media stream be stopped, after which no such media packets are received;
transmitting a second request to the server that the transmission of media packets are to be resumed; and
in response to the second request, receiving the media packets of the media stream without alteration of a presentation timeline.

44. The method of claim 43, wherein the media packets are received with a timestamp indicating the current presentation time, including the time during which the media packets were not being transmitted.

45. A computer program product, embodied in a computer-readable medium, comprising:
computer code for transmitting a first request to a server that the transmission of media packets in a media stream be stopped, after which no such media packets are received;
computer code for transmitting a second request to the server that the transmission of media packets are to be resumed; and
computer code for, in response to the second request, receiving the media packets of the media stream without alteration of a presentation timeline.

46. An apparatus, comprising:
a processor; and
a memory unit communicatively connected to the processor and including:
computer code for transmitting a first request to a server that the transmission of media packets in a media stream be stopped, after which no such media packets are received;
computer code for transmitting a second request to the server that the transmission of media packets are to be resumed; and
computer code for, in response to the second request, receiving the media packets of the media stream without alteration of a presentation timeline.

47. The apparatus of claim 46, wherein the media packets are received with a timestamp indicating the current presentation time, including the time during which the media packets were not being transmitted.

48. A method, comprising:
receiving a request from a remote device that transmission of media packets in a media stream be stopped; and
in response to the request, terminating the transmission of media packets for the media stream without adjusting a presentation timeline for the media stream.

49. The method of claim 48, further comprising:
receiving a subsequent request from the remote device that the transmission of media packets in the media stream are to be resumed; and
in response to the subsequent request, transmitting media packets of the media stream to the remote device without adjustment of the presentation timeline.

50. A computer program product, embodied in a computer-readable medium, comprising:
computer code for receiving a request from a remote device that transmission of media packets in a media stream be stopped; and
computer code for, in response to the request, terminating the transmission of media packets for the media stream without adjusting a presentation timeline for the media stream.

51. The computer program product of claim 50, further comprising:
computer code for receiving a subsequent request from the remote device that the transmission of media packets in the media stream are to be resumed; and
computer code for, in response to the subsequent request, transmitting media packets of the media stream to the remote device without adjustment of the presentation timeline.

52. An apparatus, comprising:
a processor; and
a memory unit communicatively connected to the processor and including:
computer code for receiving a request from a remote device that transmission of media packets in a media stream be stopped; and
computer code for, in response to the request, terminating the transmission of media packets for the media stream without adjusting a presentation timeline for the media stream.

53. The apparatus of claim 40, wherein the memory unit further comprises:
computer code for receiving a subsequent request from the remote device that the transmission of media packets in the media stream are to be resumed; and
computer code for, in response to the subsequent request, transmitting media packets of the media stream to the remote device without adjustment of the presentation timeline.
